(19) United States
(12) Patent Application Publication
(10) Pub. No.: US 2024/0406469 A1
(43) Pub. Date: Dec. 5, 2024

(54) MEDIA SUBSTITUTION SYSTEM

(71) Applicant: Sky CP Limited, Isleworth, Middlesex (GB)

(72) Inventors: Keith Millar, Isleworth, Middlesex (GB); Herve Murret-Labarthe, Isleworth, Middlesex (GB)

(73) Assignee: Sky CP Limited, Isleworth, Middlesex (GB)

(21) Appl. No.: 18/697,366

(22) PCT Filed: Sep. 29, 2022
(86) PCT No.: PCT/GB2022/052476

§ 371 Date: Mar. 29, 2024

(30) Foreign Application Priority Data
Sep. 30, 2021 (GB) 2114003.3

(51) Int. Cl. H04N 21/234; H04N 21/458; H04N 21/81

(52) U.S. Cl. CPC H04N 21/23424; H04N 21/458; H04N 21/812

(57) ABSTRACT

In a media substitution system, a client receives a channel including a defined break containing one or more substitutable spots. The client sends a decisioning request to a decisioning service, which determines from the decisioning request whether the client should output the linear item, or whether a substitution decision is required. In the former case, the decisioning service returns a message to the client indicating that no substitution is to take place in the relevant spot and the client outputs the linear item in the corresponding spot, without performing substitution. In the latter case, the decisioning service performs additional processing to select, from a list of items scheduled to the or each spot, an item to be output by the client in that spot, the selection being based on a profile associated with the client. The selection is communicated to the client, which outputs the selected item in the respective spot.

### FIELD OF THE INVENTION

The present invention relates to a media system with media (e.g. ad) substitution or insertion.

### BACKGROUND OF THE INVENTION

Media insertion systems involve the selection of a media item for output by a receiver during a predefined slot in a schedule either at time of broadcast or when playing back recorded or video-on-demand (VOD) programming, such as from a Personal Video Recorder (PVR). Where the programming includes content during the slot which may be replaced by media insertion, this replacement is referred to as media substitution. Such systems may be used for targeted substitutional advertising (TSA), where an advertisement or ‘ad’ (a commercial in US English) is selected for output based on a predefined user profile, without specific selection of the advertisement by the user. In a broadcast example, the user experience is similar to watching a broadcast with an advertising break, but the advertisements are tailored to the user profile. A default or linear media item may be included in the broadcast programming during the slot, for output by receivers in which media substitution is not enabled, or by receivers not targeted by the substitution.

An example of such a media substitution system is disclosed in the applicant's patent publication WO-A-2011/012909, which discloses a media substitution system in which a list of possible media items is scheduled to a specific slot within a break. The receiver stores media items which match the profile of the associated household and selects a stored media item which appears in the list for a specific slot. The receiver may apply rules to resolve constraints between selections of possible media items, which may require significant processing power. The receiver may also need periodically to obtain updates to the rules, where these need to be modified.

### STATEMENTS OF THE INVENTION

Aspects of the present invention are defined by the appended claims.

In an embodiment, a client receives a broadcast or multicast channel include a defined break containing one or more time slots. Instead of making a decision on which scheduled item to insert in a particular slot or whether to output the linear item contained within the channel, the client sends a decisioning request to a remote decisioning service, which determines from the decisioning request whether the client should output the linear item, or whether a substitution decision is required. In the former case, the decisioning service returns a message to the client indicating that no substitution is to take place in the relevant slot; for example, the response may be simply a null response. The client then outputs the linear item in the corresponding slot, without performing substitution. In the latter case, the decisioning service selects, for the or each slot, one of the items scheduled to that slot, the selection being based on a profile associated with the client. The selection is communicated to the client, which obtains the corresponding scheduled item for output in the respective slot.

The decisioning request may contain information sufficient to determine whether substitution may be required. This information may comprise channel information obtained by the client from the received channel, and/or client information specific to the client. This may reduce the processing burden on the remote decisioning service.

The decisioning service may comprise a router which performs the initial determination of whether the client should output the linear item, and a decisioning server which only receives the decisioning request from the router if the router does not determine that a linear item is to be output by the client. The decisioning server then selects, for the or each slot, one of the items scheduled to that slot, the selection being based on a profile associated with the client. The router may thereby reduce the volume of requests to the decisioning server. Another advantage is that the router may be stateless in that it only uses data provided in the request, and is therefore easy to scale.

If the request is to be routed to a decisioning server, the router may route the request to a selected one of a plurality of decisioning servers, based for example on channel information contained in the request.

The channel information may include an inactivity threshold, and the client information may include an inactivity time for the client e.g. the time since the client last detected activity by the user. There may be a determination that no substitution is required if the inactivity time exceeds the inactivity threshold. Alternatively or additionally, the channel information may include an indication of the targeted profile for the linear item in a slot i.e. the profile of subscribers to which that linear item is targeted. The client information may include a linear profile associated with the corresponding subscriber i.e. the profile of the subscriber that may be targeted by linear items. There may be a determination that no substitution is required if there is a match between the targeted profile of the linear item and the linear profile associated with the corresponding subscriber.

Alternatively or additionally, the client information may include trial information indicating whether the client is participating in a trial or is otherwise subject to different rules from other clients, and there may be a determination as to whether substitution is required based on the trial information, optionally without reference to any channel information.

### BRIEF DESCRIPTION OF THE DRAWINGS

There now follows, by way of example only, a detailed description of embodiments of the present invention, with reference to the figures identified below.

FIG. 1 is a schematic diagram of the main components of a media substitution system in an embodiment of the present invention.

FIG. 2 is a schematic diagram of a decisioning function in the embodiment, comprising a router and a decisioning server.

FIG. 3 is a diagram of the method steps involved in the operation of the media substitution system.

FIG. 4 illustrates the selection of media items for output in slots within a break in a broadcast channel.

FIG. 5 is a schematic diagram of a client in the embodiment.

FIG. 6 is a schematic diagram of a computer system in the embodiment.

### DETAILED DESCRIPTION OF THE EMBODIMENTS

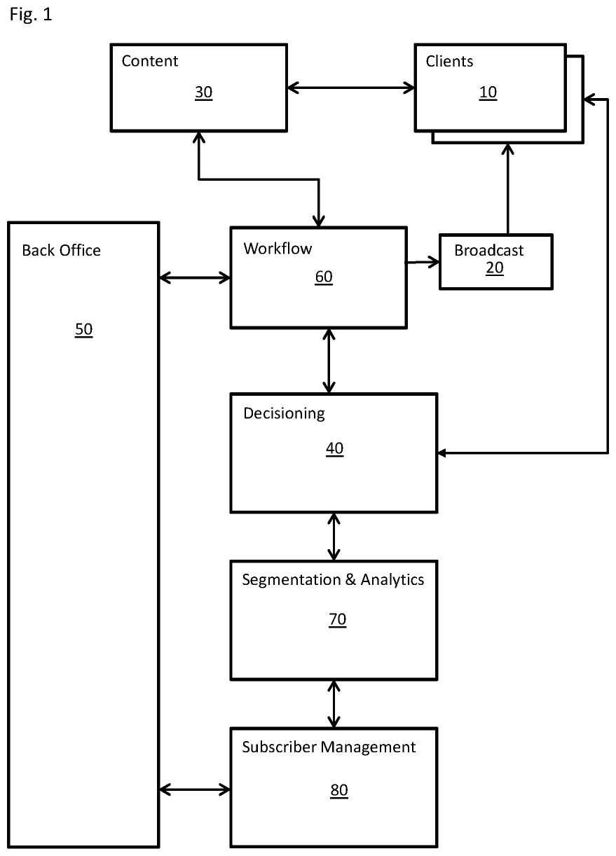

FIG. 1 shows schematically the main components of a media substitution system in an embodiment of the invention. One or more channels are broadcast or multicast to a plurality of clients 10 by a broadcast delivery system 20. The channels may be broadcast over a broadcast network, such as a satellite or cable network, and at least some of the clients 10 may be satellite or cable receivers. Alternatively or additionally, the channels may be streamed over an internet network, such as the global Internet, using for example MPEG-DASH or HLS protocols, and the clients 10 may be IPTV clients 10, such as smart TVs or streaming boxes. A hybrid approach may be used, with the one or more channels being broadcast or multicast to different ones of the clients 10 using different networks to which the respective clients are connected. Alternatively or additionally, the channel C may be cached or recorded on the client for time-shifted playback.

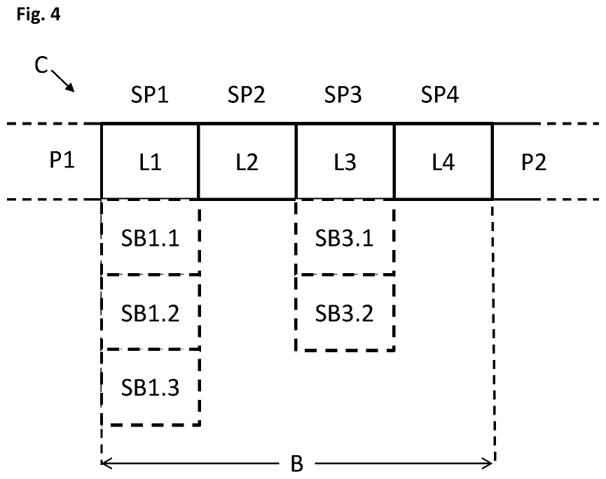

As shown in FIG. 4, at least some of the channels C include scheduled breaks B between scheduled programmes P1, P2 comprising one or more sequential time slots or spots SP1, SP2, SP3, SP4, each including a corresponding linear item L1, L2, L3, L4 such as an advertisement or ‘ad’, included within the channel C. The timing and definition of the breaks B and spots SP may be signalled in advance by metadata within or associated with the channel, such as by SCTE-35 messages, as defined in standard ANSI/SCTE 35 2013.

One or more of the spots SP1, SP3 may be defined as substitutable, such that the client 10 may replace the linear item L in the spot SP with a substitute item SB, such as an ad targeted to the subscriber(s) associated with that client 10. For each substitutable spot (e.g. SP1, SP3), there may be scheduled a respective list of substitutable items (e.g. SB1.1, SB1.2, SB1.4 for spot SP1; SB3.1, SB3.2 for slot SP3) which may be selected for output by the client 10 in that spot.

Alternatively, the client 10 may not perform substitution in a substitutable spot, but may output the linear item L instead. This may occur by default, for example if substitution is inhibited for that client 10, or none of the substitutable items has a profile segment that matches that of the client 10. Alternatively, the linear item L may be selected for output as a result of a targeting decision, for example if the linear item has a profile segment (referred to as a ‘linear segment’) that matches the profile segment of the client 10.

In the following description, the process of determining whether to substitute one or more item(s) in corresponding spot(s), and if so what item(s) to substitute, is referred to as ‘decisioning’. In contrast to the decisioning process described in WO-A-2011/012909, in the present embodiment the clients 10 do not perform decisioning locally (e.g. at the client 10); instead, decisioning is performed by a remote, shared decisioning service 40 to which the clients 10 are connected via a network e.g. the Internet, and to which the clients 10 send decisioning requests as described in more detail below.

The term ‘segment’ may refer to a predefined set of one or more attributes (e.g. age, gender, region) which are used to define a subset of viewers to which ads can be targeted. Hence, a particular user, subscriber or household may belong to one or more segments, and a particular ad or ad campaign may be targeted at one or more segments.

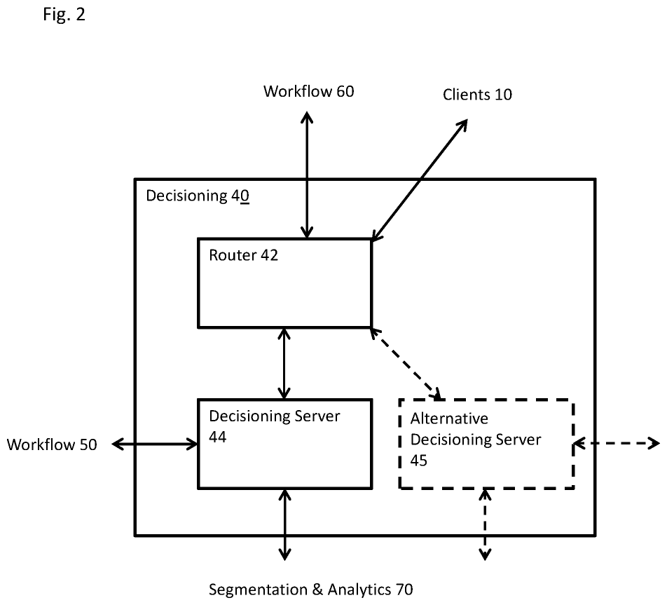

The decisioning service 40 may comprise a router 42 and a decisioning server 44, as shown for example in FIG. 2. The router 42 acts as a gateway for receiving decisioning requests from the clients 10 and determining whether to route the decisioning requests to the decisioning server 44 (or an alternative decisioning server 45), or return a response to the requesting client 10 without routing the request to the decisioning server 44 or alternative decisioning server 45. The response may be a null response indicating that no substitution is to be performed by the client 10 in the context of the request i.e. for the or each spot to which the request relates.

Alternatively, one or more functions of the router 42 may be incorporated as a process within the decisioning server 44, the process acting as a filter to determine which requests do not need consideration of substitutional ads scheduled to the relevant spot.

The description below refers to a process performed by one client 10, but it will be understood in practice that a similar process is performed by a plurality of the clients 10 using information specific to those clients 10.

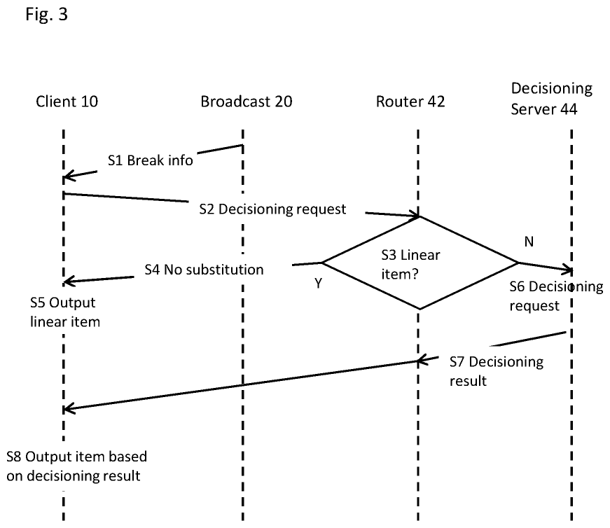

A client 10 receives information relating to the break B and the one or more substitutable spots SP1, SP3 contained in the break in the channel C (step S1 in FIG. 3). The client 10 also stores information specific to the client 10, which may be obtained during configuration of the client 10 and/or during setup of a receiving session set up with the client 10. In advance of a break defined as containing at least one substitutable spot, the client 10 sends a decisioning request to the router 42 (step S2). The decisioning request may relate to some or all of the substitutable spots within the break.

The decisioning request may comprise an HTTP GET request, and may include at least the following query fields or parameters:

TABLE 1
Decisioning Request Parameters

| Field | Description | From/relating to |
|---|---|---|
| Channel ID | Identifier of the channel for which a | Broadcast/client |
| | decision is requested | |
| Subscriber ID | Identifier of the subscriber associated | Client |
| | with the client | |
| Device ID | Identifier of the client | Client |
| Session ID | Identifier of the playback session | Client |
| Spot ID | Unique identifier of the or each spot | Broadcast/client |
| | to which the request relates | |
| Durations | List of durations of the or each spot | Broadcast Message |
| | to which the request relates | |
| Spot Linear | Linear segment(s) associated with | Broadcast Message |
| Segment | substitutable spot(s) within the break | |
| Subscriber Linear | Linear segments associated with | Client |
| Segment | the subscriber | |
| Inactivity | Inactivity threshold(s) associated with | Broadcast Message |
| threshold | substitutable spot(s) within the break | |
| Inactivity | Elapsed time since user activity detected; | Client |
| Time | alternatively, the client may report the time | |
| | when the last user activity was detected | |
| Opt Out | Flag indicating whether the subscriber has | Client |
| | opted out of targeted advertising | |
| Trial | User trials of which the subscriber is a member | Client |

The router 42 receives the decisioning request and determines from the content of the decisioning request whether the client 10 should output the linear item for the relevant spot i.e. that no substitution should take place. This determination may be performed by comparing information from or relating to the broadcast channel with information from/relating to the client. For example, the router 42 may compare the ‘Inactivity Time’ parameter (or, where the Inactivity Time indicates the time when the last user activity was detected, the time elapsed since that time) with the ‘Inactivity Threshold’ parameter, and if the former exceeds the latter, determine that no substitution should take place.

Alternatively or additionally, the router 42 may compare the ‘Subscriber linear segment’ field with the ‘Spot linear segment’ field for a spot to which the request relates. If a match is found, the router 42 may determine that no substitution should take place for that spot. The ‘Subscriber linear segment’ and ‘Spot linear segment’ parameters may take the form of bitmaps, with each bit representing a target profile of or for the linear segment. In one example, each bit represents a respective segment which may defined by one or more attributes (e.g. age range, gender, region, socioeconomic group).

In an alternative, the subscriber linear segment may be stored remotely from the client 10, for example at or at least accessible by the router 42, which looks up the subscriber linear segment using the subscriber ID in the request. This may improve data security.

Alternatively or additionally, the router 42 may compare the ‘Trial’ field with settings accessible to the router relating to user trials, which may determine whether substitution is enabled for the specific spot; if it is not, the router 42 may determine that no substitution should take place.

Where the Opt Out parameter is present and the flag is set, the router 42 may immediately determine that no substitution should take place for all the spots to which the request relates.

In an alternative, one or more of the fields identified in Table 1 as being available from the Broadcast Message, such as Spot Linear Segment and/or Inactivity Threshold, may not be available from the Broadcast Message but may instead be made available to the router 42 from another source, such as the decisioning server 44. However, this requires the router 42 to be updated with the state of the relevant channel rather than being stateless.

If the router 42 determines that no substitution should take place, the router 42 returns a ‘no substitution’ message to the client 10 (step S4), which may simply be a null message, and does not pass the decisioning request to the decisioning server 44. The client 10 responds to the ‘no substitution’ message by outputting the linear item in the relevant spot (step S5).

If the router 42 does not determine that no substitution should take place, the router passes the decisioning request to the decisioning server 44 (step S6), which performs decisioning as described in more detail below, and responds to the router 42 with a decisioning response (step S7). The router 42 then forwards the decisioning response to the client 10. Alternatively, the decisioning server 44 may send the decisioning response directly to the client 10. In either case, the client 10 outputs the item indicated by the decisioning response in the relevant spot (step S8).

The decisioning response may comprise an XML document containing decisions (e.g. indicating specific ads to be substituted, or the linear item) for the or each substitutable spot to which the corresponding decisioning request related, and is preferably compliant with the VAST (Video Ad Serving Template) specification.

The decisioning server 44 communicates with a workflow service 60 which provides an ad schedule to the decisioning server 44, based on data provided by a back office service 50. The ad schedule identifies, for each substitutable spot SP1, SP3, a corresponding list of ads or ad campaigns SB1.1-3, SB3.1-2 scheduled to that spot, together with the profile segment associated with each of the ads in the list. The list of ads may optionally include the linear ad L1, L3 within that spot, with an associated profile segment, if the linear ad is considered to be a targeted option; however, the linear ad need not be considered as a targeted option by the decisioning server 44, if the targeting of the linear ad is solely handled by the router 42.

For each decisioning request relating to a specified spot, the decisioning server 44 accesses the profile segments of the associated subscriber, for example by using the subscriber ID received in the decisioning request to retrieve the profile segments from a segmentation and analytics service 70, connected to a subscriber management service 80.

The decisioning server 44 then selects, from the list of ads corresponding to that spot in the ad schedule, the ad or ads having profile segments matching the subscriber's profile segments. There may be more than one such ad, in which case the decisioning server selects from those ads based on one or more criteria, such as priority. The selected ads may also be restricted by resolving constraints associated with ads selected for other spots within the same break, for the same client. The decisioning server 44 determines a decisioning result for the requested spot, which may identify one ad, or no ads if none meet the selection criteria for that spot.

The decisioning server 44 may use the Session ID parameter in the decisioning request to uniquely identify a viewing session of the client 10, which may be viewing of a linear channel or the playback of recorded content. The decisioning server 44 may thereby cross-reference the decisioning request to any previously received decisioning requests having the same value of the Session ID parameter, and may apply rules for ad selection based on previously received decisioning requests and corresponding decisioning results, for example separation rules relating to the interval within which the same ad, or ads within the same ad campaign, may be selected, and/or capping rules relating to the number of times that the same ad or ad campaign may be selected. The decisioning server 44 may receive impression reports indicating which ads (e.g. linear and/or substitutional ads) have been output by the client 10. The decisioning server 44 may apply capping and/or separation rules only to ads or ad campaigns for which impression reports have been received from the client 10.

The decisioning server 44 then communicates the decisioning result to the router 42, which then forwards the decisioning result to the client 10. In response to receipt of the decisioning result, the client 10 outputs the ad indicated by the decisioning result (step S8). If no ad is indicated, or the linear ad is indicated, the client 10 outputs the linear item included in the channel for the relevant spot.

As can be seen from the above description, decisioning by the decisioning server 44 may require access to the ad schedule, processing of the ad schedule for each decisioning request according to the profile segments of the associated subscriber, and resolution of constraints between ads in different spots within the same break. The router 42 bypasses this decisioning process in cases where the linear ad should be output and this can be determined from the decisioning request itself.

Where the ad indicated by the decisioning result is a substitutional ad (i.e. not the linear item), the client 10 may obtain the substitutional ad from a remote content preparation function 30, for example using an HTTP request to retrieve an MPEG-DASH playlist for the requested ad. Alternatively, the content function may be integrated with the decisioning server 44, for example by providing the playlist of the required substitutional ads to the client 10.

Alternatively, the client 10 may receive substitutional ads from a broadcast stream (e.g. from the broadcast delivery system 20) and select for local caching those substitutional ads that have been indicated by the or each decisioning result obtained for an upcoming break. The indicated substitutional ad is then played out from the local cache in the substitutional spot to which the decisioning result related.

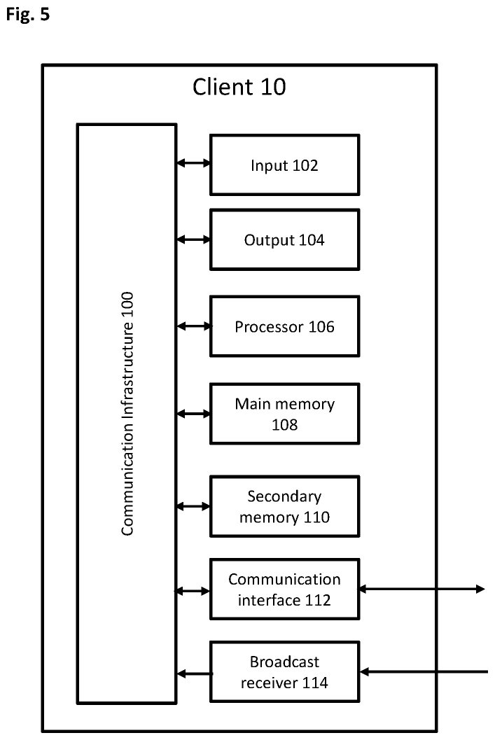

FIG. 5 shows the functional components of the client 10, including a communication infrastructure 100 such as a local bus or network through which the other components are interconnected; these components may include:
one or more processors 106, which may be a special purpose or a general-purpose digital signal processor arranged to execute one or more computer programs;
one or more input devices 102 (e.g. keys, touch panel or screen, voice input) by which the user interacts with the client 10;
one or more output devices 104 (e.g. display screen, speaker, haptic feedback device) for outputting selected content to the user of the client 10;
main memory 108 (e.g. solid state memory) to store computer program code for execution by the processor, cached media content and/or data;
secondary memory 110 (e.g. removable solid state drive) for storage of media content, computer programmes and/or data;
communication interface 112 (e.g. WiFi or other wireless interface) for communication with other devices or entities such as the decisioning service 40; and broadcast receiver 114, for receiving broadcast channels from the broadcast delivery system 20.

The client 10 may, instead of having a separate broadcast receiver 114, receive streaming content via the communication interface 112.

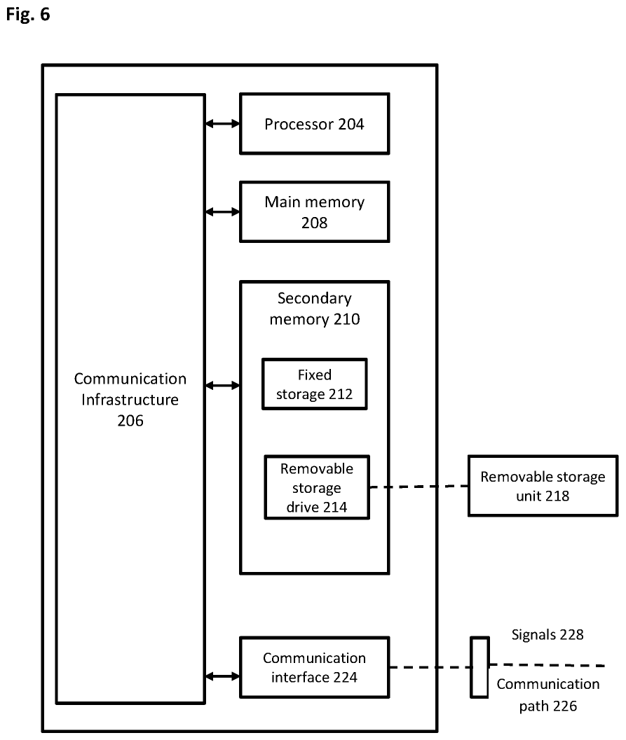

Entities and functional items described herein, such as the decisioning service 40, router 42 and/or decisioning server 44 may be implemented by computer systems such as computer system 200 as shown in FIG. 6. Embodiments of the present invention may be implemented as programme code for execution by such computer systems 200. The code may be stored on a storage medium, for example as described below. After reading this description, it will become apparent to a person skilled in the art how to implement the invention using other computer systems and/or computer architectures.

Computer system 200 includes one or more processors, such as processor 204. Processor 204 may be any type of processor, including but not limited to a special purpose or a general-purpose digital signal processor. Processor 204 is connected to a communication infrastructure 206 (for example, a bus or network). Various software implementations are described in terms of this exemplary computer system. After reading this description, it will become apparent to a person skilled in the art how to implement the invention using other computer systems and/or computer architectures.

Computer system 200 also includes a main memory 208, preferably random access memory (RAM), and may also include a secondary memory 210. Secondary memory 210 may include, for example, a hard disk or solid state drive 212 and/or a removable storage drive 214, representing for example a solid state drive, magnetic tape drive, an optical disk drive, etc. Removable storage drive 214 reads from and/or writes to a removable storage unit 218 in a well-known manner. Removable storage unit 218 represents a solid state memory, magnetic tape, optical disk, etc., which is read by and written to by removable storage drive 214. As will be appreciated, removable storage unit 218 includes a computer usable or readable storage medium having stored therein computer software and/or data.

Computer system 200 may also include a communication interface 224. Communication interface 224 allows software and data to be transferred between computer system 200 and external devices. Examples of communication interface 224 may include a modem, a network interface (such as an Ethernet card), a communication port etc. Software and data transferred via communication interface 224 are in the form of signals 228, which may be electronic, electromagnetic, optical, or other signals capable of being received by communication interface 224. These signals 228 are provided to communication interface 224 via a communication path 226. Communication path 226 carries signals 228 and may be implemented using wire or cable, fibre optics, a phone line, a wireless link, a cellular phone link, a radio frequency link, or any other suitable communication channel. For instance, communication path 226 may be implemented using a combination of channels.

The terms “computer program medium” and “computer usable medium” are used generally to refer to media such as removable storage drive 214, a hard disk or solid state memory installed in hard disk or solid state drive 212, and signals 228. These computer program products are means for providing software to computer system 200. However, these terms may also include signals (such as electrical, optical or electromagnetic signals) that embody the computer program disclosed herein.

Computer programs (also called computer control logic) are stored in main memory 208 and/or secondary memory 210. Computer programs may also be received via communication interface 224. Such computer programs, when executed, enable computer system 200 to implement embodiments of the present invention as discussed herein. Accordingly, such computer programs represent controllers of computer system 200. Where the embodiment is implemented using software, the software may be stored in a computer program product and loaded into computer system 200 using removable storage drive 214, hard disk drive 212, or communication interface 224, to provide some examples. Alternative embodiments may be implemented as control logic in hardware, firmware, or software or any combination thereof.

Alternative embodiments may be envisaged, which nevertheless fall within the scope of the following claims.

1. A media substitution system comprising a decisioning service in communication with a plurality of clients, each said client being arranged to receive at least one media channel having a break defined therein, the break comprising at least one substitutable spot containing a linear media item, and, for the or each substitutable spot, send a decisioning request to the decisioning service, the decisioning request including client data specific to that client; wherein the decisioning service is arranged to:
in an initial processing step, determine from the decisioning request whether the linear media item should be output in the corresponding substitutable spot, and if so, provide a decisioning response to the client indicating that no substitution should be performed in the corresponding substitutable spot;
and otherwise, in a further processing step, determine a media item to be output in the corresponding substitutable spot, and provide a decisioning response to the client indicating the determined item, wherein the further processing step is based on the decisioning request and on additional data not contained in the decisioning request;
wherein the client is arranged to receive the decisioning response and to output the media item or items in the or each substitutable spot, as indicated by the decisioning response.

2. The system of claim 1, wherein the decisioning request includes channel data obtained from the media channel relating to the or each substitutable spot, and the decisioning service is arranged to perform the initial processing step based on the channel data and the client data.

3. The system of claim 2, wherein the channel data includes a linear profile relating to the linear media item and the client data includes a client profile associated with the respective client, and the initial processing step includes determining that the linear item should be output in the corresponding substitutable spot if the client profile matches the linear profile.

4. The system of claim 2, wherein the channel data includes an inactivity threshold, and the client data indicates an inactivity time of the client, and wherein the decisioning service includes determining that the linear item should be output in the corresponding substitutable spot if the inactivity time exceeds the inactivity threshold.

5. The system of claim 1, wherein the client data includes a trial or opt-out indication, and wherein the initial processing step includes determining from the trial or opt-out indication that the linear item should be output in the corresponding spot.

6. The system of claim 1, wherein the additional data includes additional profile data associated with the client.

7. The system of claim 1, wherein the additional data includes schedule data indicating one or more substitutable items associated with the or each corresponding substitutable spot.

8. The system of claim 1, wherein the decisioning service comprises a router and a decisioning server, the router being arranged to receive the decisioning request and to perform the initial processing step, and if the result of the initial determination is not that the linear item is to be output, to route the decisioning request to the decisioning server; and wherein the decisioning server is arranged to perform the further processing step.

9. The system of claim 8, wherein the router is arranged to route the decisioning request to one of a plurality of decisioning servers, based on data included in the decisioning request.

10. A media substitution method in a system as claimed in claim 1, the method comprising, at the decisioning service:
receiving the decisioning request from one of said clients;
performing said initial processing step;
if the determination of the initial processing step is that the linear media item should be output in the corresponding spot, send the corresponding decisioning response to the client; and
otherwise:
perform said further processing step, and send the corresponding decisioning response to the client.

11. A media substitution method in the system of claim 8, the method comprising, at the router:
receiving the decisioning request from one of said clients;
performing said initial processing step;
if the determination of the initial processing step is that the linear media item should be output in the corresponding spot, send the corresponding decisioning response to the client; and
otherwise, passing the decisioning request to the decisioning server.

12. A media substitution method in a system as claimed in claim 1, the method comprising, at one of said clients:
receiving at least one media channel having a break defined therein, the break comprising at least one substitutable spot containing a linear media item, and for the or each substitutable spot,
sending a decisioning request to the decisioning service, the decisioning request including client data specific to that client;
receiving the decisioning result from the decisioning service; and
outputting the media item or items in the or each substitutable spot, as indicated by the decisioning response.

13. A computer readable medium comprising program code arranged to perform the method of claim 10, when executed by a suitably arranged processor or processors.
